(19) United States
(12) Patent Application Publication
(10) Pub. No.: US 2006/0198996 A1
(43) Pub. Date: Sep. 7, 2006

(54) Vapour permeable clothing

(76) Inventor: Antony Morton, Ben Rhydding (GB)

Correspondence Address: VOITH FABRICS, 3040 BLACK CREEK ROAD, P.O. BOX 1411, WILSON, NC, 27893, US

(21) Appl. No.: 11/270,994

(22) Filed: Nov. 12, 2005

(30) Foreign Application Priority Data
Nov. 12, 2004 (DE) 10 2004 054 804.8

(51) Int. Cl. D04H 13/00; B32B 27/04

(52) U.S. Cl. 428/292.1; 442/327; 428/298.1

(57) ABSTRACT

The present invention relates to a non-woven fabric having linear yarns spaced apart and extending substantially parallel to each other and a matrix structure having polymeric matrix material, wherein the matrix structure interconnects and at least partially embeds the yarns, wherein the matrix structure has filler material mixed with the polymeric matrix material and wherein the filler material has in at least one physical and/or chemical property a different behaviour to the polymeric matrix material.

### CROSS-REFERENCE TO RELATED APPLICATIONS

The present application claims priority under 35 U.S.C. §119 of German Patent Application No. 10 2004 054 804.8 filed on Nov. 12, 2004, the disclosure of which is expressly incorporated by reference herein in its entirety.

### BACKGROUND OF THE INVENTION

1. Field of the Invention

The present invention relates to non-woven fabrics, particular paper machine clothing e.g. as forming fabrics, dryer fabrics or base cloths of press felts.

2. Discussion of Background Information

Paper is conventionally manufactured by conveying a paper furnish, usually consisting of an initial slurry of cellulosic fibres, on a forming fabric or between two forming fabrics in a forming section, the nascent sheet then being passed through a pressing section and ultimately through a drying section of a papermaking machine. In the case of standard tissue paper machines, the paper web is transferred from the press fabric to a Yankee dryer cylinder and then creped.

Paper machine clothing is essentially employed to carry the paper web through these various stages of the papermaking machine. In the forming section the fibrous furnish is wet-laid onto a moving forming wire and water is encouraged to drain from it by means of suction boxes and foils. The paper web is then transferred to a press fabric that conveys it through the pressing section, where it usually passes through a series of pressure nips formed by rotating cylindrical press rolls. Water is squeezed from the paper web and into the press fabric as the web and fabric pass through the nip together. In the final stage, the paper web is transferred either to a Yankee dryer, in the case of tissue paper manufacture, or to a set of dryer cylinders upon which, aided by the clamping action of the dryer fabric, the majority of the remaining water is evaporated.

Fabrics like paper machine clothing are mainly manufactured by weaving. The yarns used for weaving can be for example of single or twisted monofilament, multifilament or spun bound type. Materials used are based on polyester, polyamide or polyphenylene sulphide (PPS).

The weaving process-is characterized in that the finished fabric comprises interwoven warp and weft yarns, whereby the warp and weft yarns cross over each other at cross-over points resulting in the fact that a woven fabric never can have totally flat surfaces. Therefore fabrics often are characterized by surface features that are predominantly made up of warp or weft dominated arrays.

For some applications it is desirable to have fabrics with flat surfaces. For example, in the dryer section one function of the dryer fabric is to give sufficient heat transfer from the heated surface e.g. of a drying cylinder to the sheet of paper. This is typically achieved by sandwiching the paper sheet between the dryer fabric and the drying cylinder. The effectiveness of the heat transfer is determined by factors such as pressure applied to press the sheet against the heated cylinder and the contact density (contact area and contact points), that means the contacting surface between the dryer fabric and the sheet.

A drawback of woven fabrics is that they are showing the property of “crimp” caused by the over and under arrangement of the warp and weft yarns.

After the weaving process mainly the warp yarns are crimped. During the heat stabilizing process, where heat and tension simultaneously is applied to the fabric, some of the crimp is lost from the warp yarns but imparted into the weft yarns, this is called “crimp interchange”.

Fabrics have to exhibit uniform properties for example characterized by their vapour and/or water permeability, caliper, surface topography, tension, dimensional stability etc. through their entire length and width. These properties have to maintain stable over their entire life time. Sometimes the performance of woven fabrics in maintaining properties over their life is not satisfactory.

As a result from the weaving process, the woven fabric has a woven structure with channels for water and vapor passage resulting in a certain water and vapor permeability of the fabric. In the forming and pressing section of a paper making machine mainly the water permeability of the fabric is important to control the liquid dewatering and to avoid rewetting of the sheet. In the dryer section mainly the vapor permeability of the fabric is important to control the passage of moisture vapor from the sheet through the fabric.

Further, woven fabrics are not easy to clean because of their complex 3-dimensional open structure. This issue becomes more and more important due to the fact that within the paper making process there is a constant drive towards more and more recycled material to be used including more contaminants. This leads to increased contaminations of the fabric.

To overcome some of the above mentioned drawbacks non woven fabrics have been proposed.

U.S. Pat. No. 3,323,226 describes a synthetic dryer fabric made by mechanical perforating polymeric sheet material.

U.S. Pat. No. 4,541,895 describes a paper makers fabric made up of a plurality of impervious non-woven sheets joined together in a laminated arrangement to define the fabric or belt. Defined throughout the fabric are drainage apertures which are created by drilling techniques.

GB 2 235 705 describes a method for manufacturing a non-woven fabric where an array of sheath core yarns of which the core has a higher melting point than the sheath, is fed in spaced parallel disposition to peripheral grooves of a pinned roller arranged in nip forming relationship with a press roll. Thereby the material of the sheath is melted as the yarns move into and through the roller nip and excess melted sheath material is forced into lateral grooves in the roller to form structural members between adjacent yarns.

All the above mentioned non-woven structures are showing unsatisfactory dimensional and thermal stability.

### SUMMARY OF THE INVENTION

It is in general an object of the present invention to provide a non-woven fabric which can be adapted to the requirements of its specific application.

It is an object of the present invention to provide a fabric that has an improved thermal and dimensional stability optionally combined with a high wear resistance.

It is further an object of the present invention to provide an non-woven fabric which can be manufactured more economically than existing non-woven fabrics.

It is in addition an object of the present invention to provide a non-woven fabric whose the permeability can be easy adjusted during manufacturing.

It is another object of the present invention to provide a method of manufacturing an above mentioned non-woven fabric.

According to a first aspect of the present invention there is provided a non-woven fabric comprising linear yarns spaced apart and extending substantially parallel to each other. The fabric further comprise a matrix structure comprising polymeric matrix material, wherein said matrix structure interconnects and at least partially embeds said yarns. The fabric according to the invention is characterized in that said matrix structure comprise filler material mixed with said polymeric matrix material that has in at least one physical and/or chemical property a different behaviour to said polymeric matrix material.

By providing a non-woven fabric comprising a matrix structure comprising a mixture of polymeric matrix material and filler material, wherein the filler material has in at least one physical and/or chemical property a different behaviour to said polymeric matrix material a fabric is created combining advantageous properties of the polymeric matrix material with advantageous properties of the filler material.

Such a fabric can be, depending on the specific choice of the polymeric matrix material and the filler material, adapted to nearly each specific requirement of its application.

With the fabric according to the invention it is further possible to combine materials which for them selves alone are not suitable for use in woven textiles, especially industrial textiles such as paper machine clothing.

By way of example, there are a variety of polymeric materials having excellent wear resistance properties but having no ability to be formed into fibres or yarns. On the other hand there are materials having excellent thermal and dimensional stability but have poor wear resistance.

According to the invention a non-woven fabric is created that combines the above mentioned advantageous properties in one single structure, what has not previously been the case for e.g. woven structures.

To create a non-woven fabric having an enhanced thermal dimensional stability according to a preferred embodiment of the present invention the filler material has a coefficient of linear thermal expansion which is smaller than the coefficient of linear thermal expansion of said polymeric matrix material in the temperature range from 20° C. to 160° C.

By providing a non-woven matrix structure which has no crimp with a mixture of polymeric material and filler material having a coefficient of linear thermal expansion which is at typical operation conditions of the fabric smaller than the coefficient of linear thermal expansion of said polymeric matrix a thermal stable fabric with low thermal expansion is provided, because the filler material reduces the thermal expansion of the whole structure.

To improve the wear resistance of the non-woven fabric it is advantageous when the polymeric matrix material has a wear resistance being higher than the wear resistance of said filler material at typical operation conditions. The wear resistance in this case is mainly determined by the polymeric matrix material due to the fact that said filler material is at least mostly incorporated in said polymeric matrix material.

Additionally, the degradation resistance of the non-woven fabric can be improved by choosing a polymeric matrix material having a hydrolytic stability and/or resistance to heat degradation being higher than the hydrolytic stability and/or resistance to heat degradation of said filler material at typical operation conditions.

The filler material can comprise, depending on the specific requirements of the application, particulate filler material and/or fibre filler material.

Depending on the specific application, the length of the fibres of the fibre filler material advantageously can be in the range of 50 μm to 500 μm, preferably 100 μm to 250 μm.

Especially to provide a fabric having high thermal dimensional stability it is advantageous when the filler material comprises oligomeric organic material and/or polymeric organic material and/or inorganic particles and/or inorganic fibres.

The oligomeric organic material can comprise Polyhedral Oligomeric Silsesquioxane polymers (POSS).

Furthermore, the inorganic particles can comprise alone or in combination nano-clays or inorganic systems based on carbide, e.g. silicon carbide (SiC) or Boron Carbide (B4C/B6C).

The inorganic fibres can comprise alone or in combination: glas, Kevlar or Nomex (polymeric materials available from DuPont). All these materials have a linear coefficient of thermal expansion being lower compared to typical thermoplastic materials. Further these materials show a high modulus.

A filler material having a high modulus in general serves to enhance at least the cross dimensional stability, e.g. intended cross machine direction, of the matrix structure compared to matrix structures only comprising polymeric matrix material.

Depending on the intended specific application of the non-woven fabric the achieved properties can be influenced by the amount of filler material added to the polymeric matrix material. Experiments performed by the applicant have shown that the properties of the matrix structure can be influenced in a wide range if said matrix structure comprise said filler material in the range of 1 weight % to 80 weight %, preferably 1 weight % to 50 weight %, most preferably 5 weight % to 30 weight %.

To generate a homogenous matrix structure having the same chemical and/or physical properties along its entire extension according to a preferred embodiment of the present invention, the filler material is homogenously mixed with the polymeric matrix material.

To achieve a matrix structure with desirable spatial changing physical and/or chemical properties, the matrix structure comprises at least one area having a content of filler material being different to another area and/or comprising filler material being different to the filler material of said another area.

The best results in respect to thermal dimensional stability for the use in the papermaking industry is achieved if the matrix structure has a coefficient of linear thermal expansion ranging from 1×10⁻⁵K⁻¹ to 5×10⁻⁵K⁻¹ for temperature range encountered on a paper machine (20° C. up to 160° C.). This leads to a fabric having a thermal expansion of less than 0.5% when heated from 20° C. to 120° C., compared to a non-woven fabric known in the art and made of typical thermoplastic elastomer material which expands in the range of 2% when heated the same amount.

According to a further embodiment of the present invention the polymeric matrix material has a melting temperature lower than the melting temperature of the linear yarns and/or than the melting temperature of the filler material.

For use in a variety of applications it is necessary that the fabric maintains its dimensions when subjected to pressure. In many applications e.g. in the press section of a papermaking machine the non-woven fabric will be subjected to pressure. To maintain its dimension when subjected to pressure according to a preferred embodiment of the present invention the matrix structure is almost non-deformable. The expression non-deformable can be explained by way of example. In the case of a non-woven fabric having apertures for being permeable to water squeezed out of the paper web in the press section of a paper making machine non-deformable has to be understood that any deformation that may take place during application of pressure would be minimal such that fluid passageways contained within the non-deformable matrix structure would remain open, thereby continuing to provide void space for the accommodation of fluid even under high pressure loading conditions.

For cost efficient processing of the non-woven fabric, e.g using extrusion processes or injection molding processes, the polymeric matrix material must have thermoplastic properties. Therefore according to a further preferred embodiment of the invention the polymeric matrix material comprise alone or in combination: thermoplastic or thermoplastic elastomer material.

The thermoplastic elastomer material for example can be any type of thermoplastic elastomer based on polyester, polyurethane, polyamide, rubber (organic or inorganic).

Thermoplastics such as polyurethanes or polyesters or polyamides or rubbers can be used for the polymeric matrix material depending on the requirements of the specific application of the fabric. Rubbers could be based on organic systems (such as EPDM types) or inorganic systems (such as Silicone types).

To increase length dimensional e.g. intended machine direction stability of the fabric according to a preferred embodiment of the present invention the linear yarns embedded in the matrix structure have a high modulus. Materials showing a high modulus and a low coefficient of linear thermal expansion are for example glas or Kevlar or Nomex.

According to a further embodiment of the invention the linear yarns are monofilament or multifilament or plied or twisted or spun bond yarns.

Depending on the specific requirements of the intended application of the non-woven fabric it is advantageous if the matrix structure forms a flat surface on at least one face of the non-woven fabric. A fabric having a flat surface on at least one surface is for example needed in the forming and dryer section. In the first case this is to reduce wire making on the sheet. In the second case in addition for example to provide a maximum contact area between the paper sheet and the drying cylinder to achieve maximum heat transfer between the drying cylinder and the sheet. Further unwanted air carriage of the moving fabric is reduced on the flat surface. This is an important feature due to the fact of continuously increasing paper machine speeds.

For other purposes, for example in the tissue paper making process it is desirable to create a patterned structure onto the tissue sheet. For this application according to a preferred embodiment of the invention the matrix structure forms a textured surface on at least one face of said non-woven fabric.

For some applications e.g. smoothing or transfer belts where no water has to be removed from the paper sheet there is no need for the fabric to be permeable. For other applications where water and/or vapour has to be removed from the sheet the non-woven fabric must have a predetermined certain permeability. Therefore the non-woven fabric comprise apertures extending through the matrix structure.

To achieve a predetermined permeability the apertures can have any thinkable geometrical shape like straight through holes or conical holes. Further the apertures can extend substantially perpendicular to the general plain of the fabric. The shape of the apertures is also an important factor in regard to the ability of being cleaned. Therefore when designing the apertures the cleaning ability also can be taken into consideration.

For designing the apertures all the above mentioned factors can be considered without the limited flexibility being inherent to woven structures.

To achieve a uniform drainage characteristic throughout the non-woven fabric it is advantageous if the apertures are uniformly spaced.

To achieve a non-uniform, or zonal difference, drainage characteristic throughout the non-woven fabric it is advantageous if the apertures are not uniformly spaced.

For some application especially to avoid hydraulic marking it is advantageous if the apertures are randomly spaced by maintaining a uniform permeability all over the non-woven fabric.

According to a further embodiment of the invention depending on the specific application the apertures can be straight through holes or conical holes or posses a tortuous, non linear path through the z direction of the structure. Therefore any geometric design suitable for the specific application is possible.

Further the apertures are in laterally offset disposition relative to said linear yarns.

Depending on the distribution, the size and the shape of the apertures a wide range of permeability can be adjusted. The fabric according to the invention therefore can have a permeability in the range of 20 cfm to 1000 cfm, which can be selected according to the specific requirements of its intended application.

To mostly prevent the load bearing linear yarns from extending due to the environmental conditions the fabric is subjected to during its operation it is advantageous if the linear yarns are fully embedded in the matrix structure.

According to a second aspect of the invention there is provided a paper machine clothing comprising at least one of the above described non-woven fabrics.

A plurality of the non-woven fabrics can be joined together in a face to face manner to generate a laminated structure comprising a plurality of such non-woven fabrics. To generate a structure having a width being greater as the width of one of said non-woven fabrics said non-woven fabrics can be joined together in a side by side manner.

If the paper machine clothing is for example a press felt it is possible that at least one surface of said non-woven fabric is covered by a porous layer. This porous layer can for example form the sheet contacting surface of the paper machine clothing.

Further the porous layer can comprise a textile batt and/or foam material.

One of the advantages of the present invention is that, due to the fact that the non-woven fabric comprises linear spaced apart extending yarns at least partially embedded in a matrix structure, wherein the matrix structure comprises a mixture of a polymeric matrix material and a filler material, wherein the filler material has at least one physical and/or chemical property a different behaviour to said polymeric matrix material, that the non-woven fabric is applicable for almost all applications in a paper machine. Therefore according to a preferred embodiment of the present invention the paper machine clothing comprising the non-woven fabric can be a forming or dryer fabric, a press felt or press belt, a smoothing or transfer belt.

The invention also includes a method of manufacturing a non-woven fabric comprising the steps of forming a matrix structure comprising filler material and polymeric matrix material and applying spaced appart linear yarns substantially extending parallel to each other during or after formation of said matrix structure at a molten stage of said polymeric matrix material in such a way to said matrix structure that said yarns are at least in part embedded into said matrix structure and interconnected by said matrix structure.

To manufacture a non-woven fabric according to the invention having apertures extending through the matrix structure the apertures can be provided by drilling. Apertures can be provided by mechanical drilling/punching methods. Also blasting methods can be used, such as water jet or particulate (grit). Apertures can also created by an ablative process, such as that produced by laser. The laser for ablation can be a CO2 or Nd:YAG laser.

It is further possible to provide the apertures during the manufacturing step producing the matrix structure. Therefore the method can further comprise the steps of applying the spaced apart yarns to a mixture comprising molten polymeric material and filler material, constraining subsequent flow movement of the mixture of polymeric and filler material to predetermined paths extending between and cross linking adjacent yarns to form the non-woven fabric with apertures.

Alternatively core/sheath yarns can be used to produce the non-woven fabric according to the invention. The core/sheath yarns can be made by extrusion techniques producing a core/sheath yarn having a monofilament core and a sheath comprising polymeric material mixed with filler material. In this case the method further comprises the steps of providing spaced apart sheath/core yarns, each of the sheath/core yarns comprising a core yarn and a sheath, the sheath comprising polymeric material mixed with filler material, heating the sheath/core yarns to melt said polymeric material, constraining subsequent flow movement of said mixture of polymeric and filler material to predetermined paths extending between and cross linking said adjacent core yarns to form the non-woven fabric with apertures.

By doing this a non-woven fabric having apertures is formed, wherein the core yarns form the linear extending spaced apart reinforcing yarns being embedded in a matrix structure comprising polymeric matrix material and filler material, being provided by the sheath material.

Further the method can comprise that the flow movement of the mixture of polymeric and filler material is constrained to individual paths arranged in spaced apart disposition in the longitudinal direction of said yarns.

The predetermined paths can be provided by a pinned drum.

To guaranty the full formation and proper distribution of the polymeric material mixed with the filler material according to a preferred embodiment of the present invention it is foreseen that the flow movement of the mixture of polymeric and filler material is influenced by pressure applied to the mixture of polymeric and filler material perpendicular to the flow moving directions.

The pressure can be provided by a press-nip formed between the pinned drum and a press roll or a doctor blade.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a top view of a non-woven fabric according to a first embodiment of the invention;

FIG. 2 is a side view of the non-woven fabric of FIG. 1;

FIG. 3 is a top view of a non-woven fabric according to a second embodiment of the invention;

FIG. 4 is a side view of an apparatus to perform the method according to the invention; and

FIG. 5 is a cross sectional view of a core/sheath yarn.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

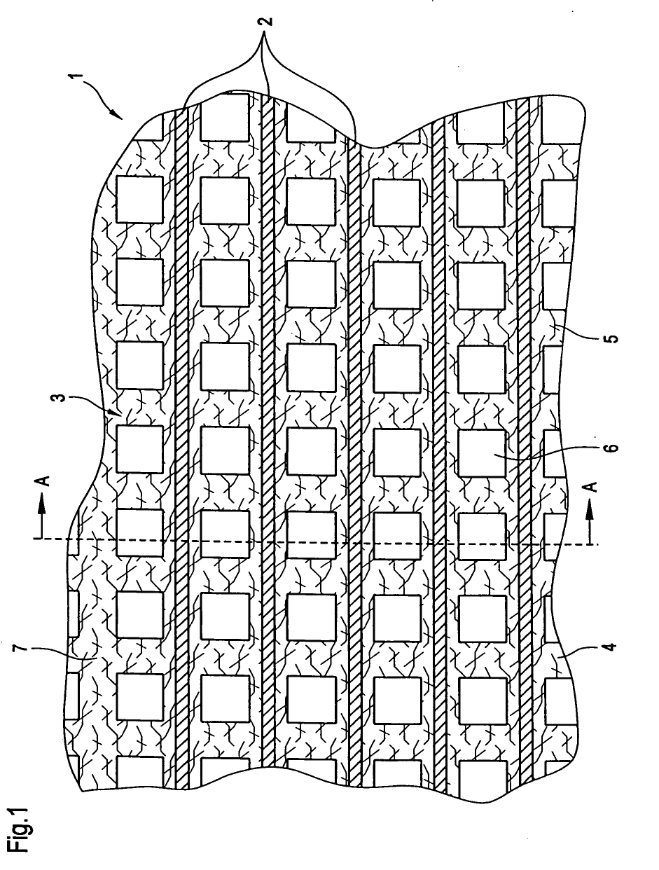

FIG. 1 is showing a view onto a face 7 of a part of a non-woven fabric 1 according to a first embodiment of the invention. The non-woven fabric 1 shown in FIG. 1 is for use in a paper machine.

The non-woven fabric 1 comprises apertures 6 extending through the fabric 1 and being uniformly spaced. In the specific embodiment of FIG. 1 the apertures 6 are conical holes giving the fabric 1 a permeability of 750 cfm. The scope of the invention is not limited to conical holes. Depending on the specific application any thinkable geometry could be used. Also, the permeability depends on the specific application requirement and can be in the range of 20 cfm to 1000 cfm.

The apertures 6 provide individual flow passages substantially perpendicular to the general plane of the fabric 1 lying in the plane of the drawing.

The non-woven fabric 1 further comprises linear spaced apart yarns 2 extending substantially parallel to each other. The yarns are monofilament yarns 2 made from extruded and drawn thermoplastic material. This is most typically based on polyester for dryer application. For other parts of the paper machine polyamide based yarns can be used. Other materials such as PPS (polyphenylene sulphide) and PEEK (polyetherether ketone) could also be used. For applications other than for the dryer section it may be possible to use multifilament, spun, glass reinforced plied yarns etc.

Further the non-woven fabric comprises a matrix structure 3 comprising polymeric matrix material 4 and filler material 5 mixed with the polymeric matrix material 4. The matrix structure 3 forms a flat surface on face 7 of said non-woven fabric 1.

The apertures 6 are provided in the matrix structure 3. Further the apertures 6 are in laterally offset disposition relative to the linear yarns 2.

The matrix structure 3 interconnects and fully embeds the yarns 2. The yarns 2 extend in the intended machine direction (MD) of the fabric 1 and serve as reinforcing yarns.

The filler material 5 of the embodiment shown in FIG. 1 is in fibre form and has according to the invention in at least one physical and/or chemical property a different behaviour to the polymeric matrix material 4.

In the embodiment shown in FIG. 1 the fibres providing the filler material 5 has a coefficient of linear thermal expansion which is smaller than the coefficient of thermal expansion of said polymeric matrix material in the temperature range typical in paper machines. The fibres 5 are glas fibres. The fibres 5 in the embodiment shown in FIG. 1 have a length distribution in the range from 100 μm to 250 μm. It also could have been possible to select fibres only having one specific length. Further the fibres 5 are added to the polymeric material 4 so that the matrix structure 3 comprise the fibres 5 in an amount in the range of 25 weight %.

Further the fibres 5 are homogenously distributed in the polymeric matrix material 4. Further the fibres 5 have non preferred orientation in the polymeric matrix material 4 so that the matrix structure 3 has an isotropic behaviour in its properties. It also could have been possible to provide the fibres 5 with a preferred orientation to give the matrix structure 3 an anisotropic behaviour.

Further the polymeric matrix material 4 has a wear resistance being higher than the wear resistance of the filler material 5. In the specific embodiment shown in FIG. 1 the polymeric matrix material 4 comprise polyurethane which has an excellent wear resistance. For application in the dryer section it is advantageous if the polymeric matrix material 4 comprise or is a thermoplastic elastomer based material.

The matrix structure 3 comprising said polymeric material 4 mixed with said fibres has a coefficient of linear thermal expansion ranging from 1×10⁻⁵K⁻¹ to 5×10⁻⁵K⁻¹ over the temperature range typically encountered within a paper making machine. This leads to an expansion of the non-woven fabric 1 when heated from 20° C. to 120° C. of around 0.5%.

By way of comparison polyurethane alone (without filler) has a coefficient of linear thermal expansion of greater than 1×10⁻⁴K⁻¹, leading to an expansion of the non-woven fabric when exposed to the full temperature range likely to be encountered on a paper making machine of around 2.0%.

Therefore the fabric 1 according to the invention has a increased thermal dimensional stability.

Further the polymeric matrix material 4 has a melting temperature being lower than the melting temperature of the linear yarns 2 and the melting temperature of the filler fibres 5. In addition the fibres 5 and the yarns 2 have a higher modulus than the polymeric matrix material 4. Typical values for the modulus are for example 50-100 GPa for glass and 0.02-4 GPa for thermoplastics and thermoplastic elastomers.

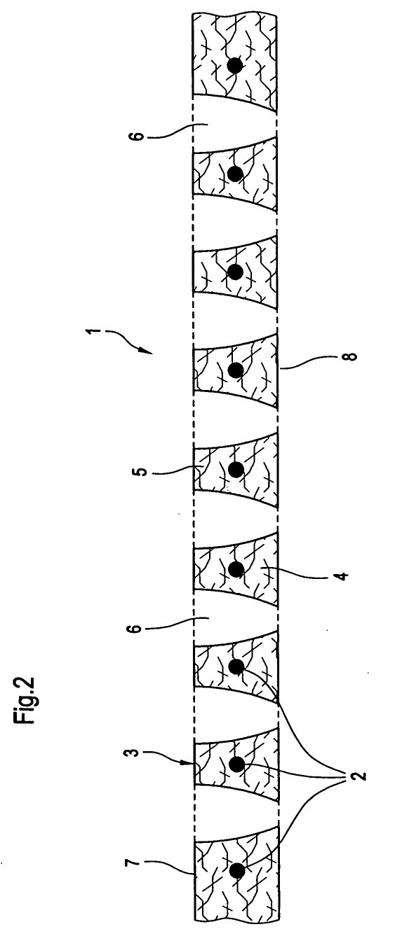

Referring now to FIG. 2 which shows a cross sectional view of the non-woven fabric 1 along the line A-A cutting through the apertures 6.

As can be seen the matrix structure 3 forms flat surfaces on faces 7 and 8 of the non-woven fabric 1.

In FIG. 2 the yarns 2 extend perpendicular to the plane of drawing.

Apertures 6 extend through the matrix structure 3 and showing a conical/tapered shape.

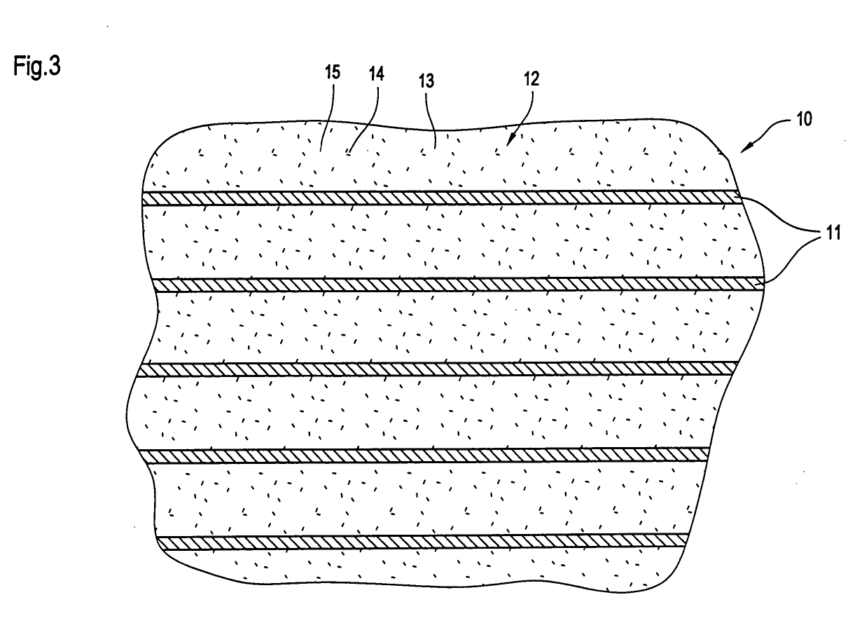

FIG. 3 is a top view onto a face 15 of a part of a non-woven fabric 10 according to a second embodiment of the invention. The non-woven fabric 10 shown in FIG. 3 is for the use in a paper machine clothing e.g. as a transfer belt.

The non-woven fabric 10 comprises no apertures and therefore is not permeable. Further the non-woven fabric 10 comprise linear spaced apart yarns 11 extending substantially parallel to each other. The yarns 11 are monofilament yarns and made from thermoplastic polyester (PET) that has been extruded and drawn.

Further the non-woven fabric comprise a matrix structure 12 comprising polymeric matrix material 13 and filler material 14 mixed with the polymeric matrix material 13. The matrix structure 12 forms a flat surface on face 15 of the non-woven fabric 10.

The matrix structure 12 interconnects and fully embeds the yarns 11. The yarns 1I1 extend in the intended machine direction (MD) of the fabric 10 and serve as reinforcing yarns.

The filler material 14 of the embodiment shown in FIG. 3 is in particulate form and has according to the invention in at least one physical and/or chemical property a different behaviour to the polymeric matrix material 13.

In the embodiment shown in FIG. 3 the particles 14 providing the filler material 14 have an abrasion resistance which is lower than that of said polymeric matrix material 13. The particles 14 comprise SiC. It also could have been that all the particles would have one specific particle size selected from the above mentioned range. Further the particles 14 are added to the polymeric material 13 so that the matrix structure 12 comprise the particles 14 in an amount in the range of 20 weight %.

Further the particles 14 are homogenous distributed in the polymeric matrix material 13.

In the embodiment shown in FIG. 3 the polymeric matrix material 13 comprise thermoplastic elastomer based on polyester.

It has to be understood that the invention also has particulate filler material in a matrix structure having apertures. Also it has to be understood that the invention covers embodiments having fibre filler material in a matrix structure having no apertures.

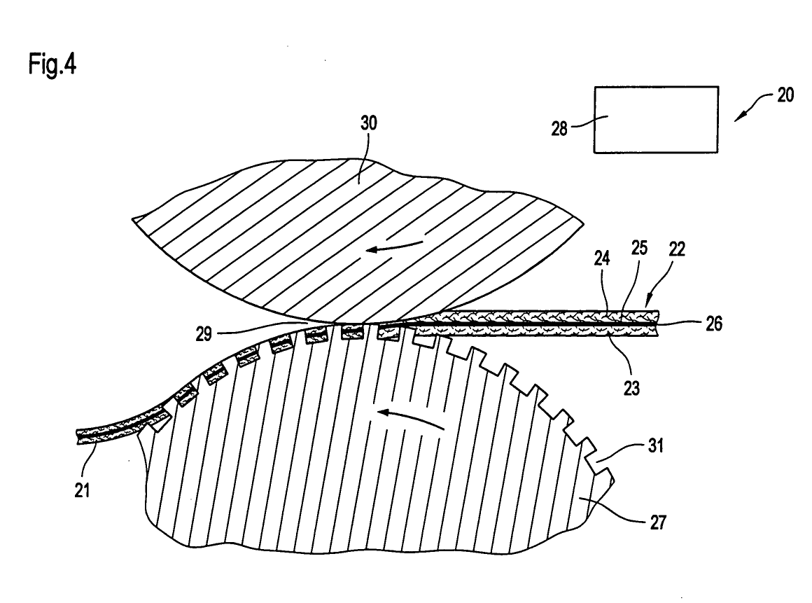

FIG. 4 shows a cross sectional side view of an apparatus 20 to perform the method of manufacturing a non-woven fabric 21 according to the invention.

An array of linear spaced apart core/sheath yarns 22 is fed onto a rotating pinned drum 27. Each of said yarns 22 have a sheath 23 comprising a mixture of polymeric material 24 and filler material 25 embedding a polymeric core yarn 26. The polymeric material 24 has a melting temperature which is lower than the melting temperature of the filler material 25 and of the core yarns 26. The core/sheath yarns 22 are heated by a heating supply 28 to melt the polymeric material 24 without melting the filler material 25 and the core yarn 26.

The core/sheath yarns 22 can be melted by direct impingement of electromagnetic radiation (infra-red, microwave etc . . . ) or they can be melted through an induction effect whereby the surface temperature of the pin-drum 27 is raised by an induction heater to a temperature that is above the melting temperature of the sheath material 24, but below the melting temperature of the core yarns 26 or the filler material 25.

The molten polymeric material 24 and the filler material 25 is subjected to pressure provided by a press-nip 29 formed by the pinned drum 27 and a press roll 30.

The pressure is applied perpendicular to the intended flow movement direction of the mixture of the molten polymeric material 24 and filler material 25 and forces mixture 24 and 25 to flow along predetermined paths 31, provided by the pinned drum 27, to extend between and to cross link adjacent core yarns 26. Further the pressure forces the mixture of molten polymeric material 24 and filler material 25 to flow along individual paths in the longitudinal direction of the core yarns 26. The paths are provided by the pinned drum 27 and arranged in spaced apart disposition.

By doing this, the non-woven fabric 21 is formed, wherein said core yarns 26 provides aforesaid yarns 2 and/or 11, said polymeric material 24 provides aforesaid polymeric matrix material 4 and/or 13 and said filler material provides aforesaid filler material 5 and/or 14 described in FIGS. 1, 2 and 3.

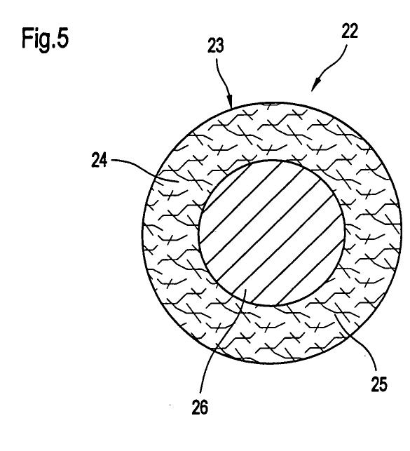

FIG. 5 is showing a cross sectional view of the core/sheath yarn 22 used to perform the method described above. The core/sheath yarn has been manufactured by a conventional extrusion technique.

As can be seen the core/sheath yarn has a core 26 being fully embedded in a sheath 23. The sheath 23 comprises a mixture of polymeric material 24 and filler material 25. The polymeric material 24 has a melting temperature which is lower than the melting temperature of the filler material 25 and of the core yarns 26.

While the invention has been described in detail, it will be apparent to one skilled in the art that various changes and modifications can be made therein without departing from the spirit and scope thereof.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Charges may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A non-woven fabric comprising:
linear yarns spaced apart and extending substantially parallel to each other and
a matrix structure comprising polymeric matrix material, wherein said matrix structure interconnects and at least partially embeds said yarns,
wherein the matrix structure further comprises filler material mixed with said polymeric matrix material, and
wherein said filler material has in at least one of a physical and chemical property that has a different behaviour to said polymeric matrix material.

2. The non-woven fabric according to claim 1,
wherein said filler material has a coefficient of linear thermal expansion which is smaller than the coefficient of thermal expansion of said polymeric matrix material at least in a temperature range from 20° C. to 160° C.

3. The non-woven fabric according to claim 1,
wherein said polymeric matrix material has a wear resistance higher than the wear resistance of said filler material.

4. The non-woven fabric according to claim 1,
wherein said polymeric matrix material has at least one of a hydrolytic stability and resistance to heat degradation being higher than at least one of hydrolytic stability and resistance to heat degradation of said filler material.

5. The non-woven fabric according to claim l,wherein said filler material comprises at least one of particulate filler material and fibre filler material.

6. The non-woven fabric according to claim 5,
wherein the fibres of said fibre filler material have a length in the range of 50 μm to 500 μm.

7. The non-woven fabric according to claim 1, wherein said filler material comprises at least one of oligomeric organic material, polymeric organic material, inorganic particles and inorganic fibres.

8. The non-woven fabric according to claim 7,
wherein said oligomeric organic material comprise polyhedral oligomeric silsesquioxane polymers.

9. The non-woven fabric according to claim 7,
wherein said inorganic particles comprises at least one of nano-clays, SiC and Boron Carbide.

10. The non-woven fabric according to claim 7,
wherein said inorganic fibres comprise at least one of glas, Kevlar and Nomex.

11. The non-woven fabric according to claim 1,
wherein said matrix structure comprises said filler material in the range of 1 weight % to 80 weight %.

12. The non-woven fabric according to claim 1,
wherein said matrix structure comprises said fibre filler material in the range of 5-20 weight %.

13. The non-woven fabric according to claim 1,
wherein said matrix structure comprise said particulate filler material in the range of 5-50 weight %.

14. The non-woven fabric according to claim 1,
wherein said filler material is homogeneously mixed in said polymeric matrix material.

15. Non-woven fabric according to claim 1,
wherein said matrix structure comprises at least a first area with a content of filler material being higher compared to a second area.

16. The non-woven fabric according to claim 1,
wherein said matrix structure comprising filler material has a coefficient of linear thermal expansion ranging from 1×10⁻⁵K⁻¹ to 5×10⁻⁵K⁻¹.

17. The non-woven fabric according to claim 1,
wherein said polymeric matrix material has a melting temperature being lower than the melting temperature of at least one of said linear yarns and the filler material.

18. The non-woven fabric according to claim 1,
wherein said matrix structure is almost non-deformable.

19. The non-woven fabric according to claim 1,
wherein said polymeric matrix material comprises at least one of a thermoplastic, a thermoplastic elastomer material, a thermoplastic elastomer based polyester, polyurethane, polyamide, organic rubber and inorganic rubber.

20. The non-woven fabric according to claim 1,
wherein said linear yarns have a high modulus.

21. The non-woven fabric according to claim 1,
wherein said linear yarns are at least one of monofilament yarns, multifilament yarns, plied yarns, twisted yarns, and spun bond yarns.

22. The non-woven fabric according to claim 1,
wherein said linear yarns comprise inorganic material.

23. The non-woven fabric according to claim 1,
wherein said matrix structure forms a flat surface on at least one face of said non-woven fabric.

24. The non-woven fabric according to claim 1,
wherein said matrix structure forms a textured surface on at least one face of said non-woven fabric.

25. The non-woven fabric according to claim 1,
wherein said non-woven fabric comprises apertures extending through said matrix structure.

26. The non-woven fabric according to claim 25,
wherein said apertures are uniformly spaced.

27. The non-woven fabric according to claim 25,
wherein said apertures are in laterally offset disposition relative to said linear yarns.

28. The non-woven fabric according to claim 25,
wherein said apertures are straight through holes or conical holes.

29. The non-woven fabric according to claim 1,
wherein said fabric has a permeability in the range of 20 cfm to 1000 cfm.

30. The non-woven fabric according to claim 25,
wherein said apertures in the matrix structure comprise respective individual flow passages substantially perpendicular to the general plane of said fabric.

31. The non-woven fabric according to claim 1,
wherein said linear yarns are fully embedded in said matrix structure.

32. Paper machine clothing comprising at least one non-woven fabric according to claim 1.

33. The paper machine clothing according to claim 32,
wherein said paper machine clothing comprises a plurality of said non-woven fabrics joined together in at least one of a laminated manner and side by side manner.

34. The paper machine clothing according to claim 32,
wherein at least one surface of said non-woven fabric is covered by a porous layer.

35. The paper machine clothing according to claim 34,
wherein said porous layer comprise a textile batt.

36. The paper machine clothing according to claim 32,
wherein said paper machine clothing is one of a forming fabric, a dryer fabric, a press felt, a press belt, a smoothing belt and a transfer belt.

37. A method of manufacturing a non-woven fabric comprising the steps of forming a matrix structure comprising filler material and polymeric matrix material and applying spaced apart linear yarns substantially extending parallel to each other during or after formation of said matrix structure at a molten stage of said polymeric matrix material in such a way to said matrix structure that said yarns are at least in part embedded into said matrix structure and interconnected by said matrix structure.

38. The method according to claim 37,
wherein the method further comprises the step of providing apertures extending through said matrix structure by at least one of drilling an ablation.

39. The method according to claim 38,
wherein said ablation is performed by laser ablation.

40. The method according to claim 37,
wherein the method further comprises the steps of applying said spaced apart yarns to a mixture comprising molten polymeric material and filler material, constraining subsequent flow movement of said mixture of polymeric and filler material to predetermined paths extending between and cross linking adjacent yarns to form said non-woven fabric with apertures.

41. The method according to claim 40,
wherein said polymeric material provides the polymeric matrix material of said matrix structure.

42. The method according to claim 37,
wherein the method further comprises the steps of providing spaced apart sheath/core yarns, each of said sheath/core yarns comprising a core yarn and a sheath, the sheath comprising polymeric material mixed with filler material, heating the sheath/core yarns to melt said polymeric material, constraining subsequent flow movement of said mixture of polymeric and filler material to predetermined paths extending between and cross linking said adjacent yarns to form said non-woven fabric with apertures.

43. The method according to claim 42,
wherein said core yarn provides aforesaid yarn and said polymeric material provides said polymeric matrix material.

44. The method according to claim 40,
wherein the flow movement of the mixture of polymeric and filler material is constrained to individual paths arranged in spaced apart disposition in the longitudinal direction of said core yarns.

45. The method according to claim 40,
wherein the paths are provided by a pinned drum.

46. The method according to claim 37,
wherein flow movement of the mixture of polymeric and filler material is influenced by pressure applied to the mixture of polymeric and filler material perpendicular to the flow moving directions.

47. The method according to claim 46,
wherein the pressure is provided by a press-nip formed between at least one of the pinned drum and a press roll and a doctor blade.

48. The non-woven fabric according to claim 5, wherein the fibres of said fibre filler material have a length in the range of 100 μm to 250 μm.

49. The non-woven fabric according to claim 1, wherein said matrix structure comprises said filler material in the range of 1 weight % to 50 weight %.

50. The non-woven fabric according to claim 1, wherein said matrix structure comprises said filler material in the range of 5 weight % to 30 weight %.

51. The non-woven fabric according to claim 1, wherein said matrix structure comprises said fibre filler material in the range of 8-12 weight %.

52. The non-woven fabric according to claim 1, wherein said matrix structure comprise said particulate filler material in the range of 10-30 weight %.

53. The non-woven fabric according to claim 1
wherein said linear yarns comprise inorganic material and at least one of glas, Kevlar and Nomex.
